(19) United States
(12) Patent Application Publication
(10) Pub. No.: US 2026/0017604 A1
(43) Pub. Date: Jan. 15, 2026

(54) SYSTEM AND METHOD FOR MANAGING ISSUANCE OF SECURE WAYBILL USING BLOCKCHAIN TECHNOLOGY AND VIRTUAL PERSONAL INFORMATION

(71) Applicant: HOMENUMBER CO., LTD., Seoul (KR)

(72) Inventors: Nam Seob JO, Seoul (KR); Chan Heui PARK, Seoul (KR)

(21) Appl. No.: 19/334,980

(22) Filed: Sep. 22, 2025

Related U.S. Application Data
(63) Continuation of application No. PCT/KR2024/003220, filed on Mar. 13, 2024.

(30) Foreign Application Priority Data
Mar. 23, 2023 (KR) 10-2023-0037758

(51) Int. Cl. G06Q 10/083; G06F 21/62; G06Q 10/0835

(52) U.S. Cl. CPC G06Q 10/0838; G06F 21/6245; G06Q 10/0835; G06Q 2220/00

(57) ABSTRACT

Provided enables more safe and convenient output of a waybill without personal information leakage by using virtual personal information instead of actual personal information when a customer purchases a product from each online shopping mall, checking an online shopping mall customer order number to prevent fraudulent issuance of the waybill when outputting the waybill, and not storing identity information of the customer in a primary product supplier system and a subordinate product supplier system of the online shopping mall, and is characterized by including a customer terminal, a secure waybill management means, a shopping mall system, a primary product supplier system, secondary to Nth product supplier systems.

### TECHNICAL FIELD

The present invention relates to a system and method for managing issuance of a secure waybill using blockchain technology and virtual personal information, and more particularly to a system and method for managing issuance of a secure waybill using blockchain technology and virtual personal information capable of more safely and conveniently outputting a waybill without personal information leakage by using virtual personal information instead of actual personal information when a customer purchases a product from each online shopping mall, checking an online shopping mall customer order number to prevent fraudulent issuance of the waybill when outputting the waybill, and not storing identity information of the customer in a primary product supplier system and a subordinate product supplier system of the online shopping mall.

### BACKGROUND ART

As the online shopping market has grown rapidly in modern society, the risk of leakage of personal information of product recipients by online sellers such as home shopping and internet shopping malls, as well as businesses that receive actual personal information of the product recipients from the online sellers, has greatly increased in a delivery process for products ordered by customers.

As personal information protection laws are strengthened to protect personal information, such as customer information, the responsibilities of online sellers and delivery companies have been increasing.

To address this problem, technologies have been devised to allow delivery services to be processed without storing actual personal information of recipients in processing systems owned by a plurality of providers in charge of the delivery services.

As briefly illustrated in FIG. 1, examples of a method to which such technology is applied may include a first method (see (A) of FIG. 1) in which each of Internet shopping malls A and B (11 and 12), etc. independently establishes a secure waybill output system for customer order information of an orderer a (10), who is a customer, and a business partner 1 (13), which is in charge of a delivery service, accesses each output system and outputs a secure waybill, and a second method (see (B) of FIG. 1) in which a separate independent hub system 30 is established so that personal information of a recipient according to order information of an orderer b (20), who is a customer, may be received from a plurality of Internet shopping malls X and Y (21 and 22), etc. to output a waybill, and a business partner 2 (23), which is in charge of a delivery service, accesses the hub system and outputs a secure waybill.

However, the first method or the second method has problems of inconvenience of having to input actual personal information of a recipient to each online shopping mall when ordering a product and possibilities of exposure to a risk of a massive leakage of personal information and fraudulent issuance of a waybill since the personal information of the recipient input when ordering is stored in an online shopping mall, a hub system, etc.

Accordingly, measures are required to provide an independent system for managing actual personal information of a recipient for eliminating inconvenience in which a customer has to input personal information such as a name, a phone number, and an address as delivery information for each online shopping mall or for each order when placing an order of a product for delivery, preventing actual personal information of the recipient from being stored in the online shopping mall, and preventing the actual personal information of the recipient from being stored in duplicate for each order in a hub system, and to provide a secure waybill management means for blocking fraudulent issuance of a waybill by checking a customer order number provided from a shopping mall system when outputting a secure waybill using virtual personal information, thereby being able to prevent a risk of a massive leakage of actual personal information of the recipient.

Therefore, the present invention proposes technology related to a system and method for managing issuance of a secure waybill using blockchain technology and virtual personal information capable of more safely and conveniently outputting a waybill without personal information leakage by using virtual personal information instead of actual personal information when a customer purchases a product from each online shopping mall, checking an online shopping mall customer order number to prevent fraudulent issuance of the waybill when outputting the waybill, and not storing identity information of the customer in a primary product supplier system and a subordinate product supplier system of the online shopping mall.

### Citation List

(Patent Document) Republic of Korea Patent No. 10-1206473 (Dec. 24, 2012)

### DISCLOSURE

### Technical Problem

It is an object of the present invention to be able to more safely and conveniently output a waybill without personal information leakage by using virtual personal information instead of actual personal information when a customer purchases a product from each online shopping mall, checking an online shopping mall customer order number to prevent fraudulent issuance of the waybill when outputting the waybill, and not storing identity information of the customer in a primary product supplier system and a subordinate product supplier system of the online shopping mall.

### Technical Solution

A system for managing issuance of a secure waybill using blockchain technology and virtual personal information, which is the present invention for solving the above-mentioned problem, is characterized by including

a customer terminal (100) configured to provide actual personal information of a customer to a secure waybill management means (200), receive virtual personal information of the customer corresponding to the actual personal information of the customer, and provide order information and the virtual personal information to a shopping mall system (300) for product purchase,

the secure waybill management means (200) configured to generate the virtual personal information of the customer corresponding to the actual personal information of the customer provided by the customer terminal (100), provide the generated virtual personal information to the customer terminal (100), store and manage the virtual personal information and the actual personal information of the customer using blockchain technology, form, store, and manage shopping mall access account relationship information of a primary product supplier and secondary to Nth product suppliers according to an access account registration request from the primary product supplier system (400), determine whether to generate waybill information using information provided by the shopping mall system (300) and the product supplier systems (400 and 500), and transmit the generated waybill information to an output unit of a product supplier system requesting waybill output so that the waybill information is output,

the shopping mall system (300) configured to generate customer order information including the virtual personal information and a customer order number using the order information and the virtual personal information provided by the customer terminal (100), provide customer order information excluding the virtual personal information in the generated customer order information to the primary product supplier system (400), and provide the customer order information, shopping mall access account information of the primary product supplier system, and order status information to the secure waybill management means (200),

the primary product supplier system (400) configured to request that the secure waybill management means (200) register a shopping mall access account thereof and register the secondary to Nth product suppliers, which are subordinate product suppliers thereof, in the shopping mall access account thereof, generate delivery information using customer order information excluding the virtual personal information provided by the shopping mall system (300) when the primary product supplier system (400) supplies a purchased product of the customer, request waybill output simultaneously with providing the generated delivery information to the secure waybill management means (200), and provide the customer order information excluding the virtual personal information provided by the shopping mall system (300) to a subordinate product supplier system to provide a product without generating delivery information when the purchased product of the customer is supplied through a subordinate product supplier system thereof, and

the secondary to Nth product supplier systems (500) configured to generate delivery information using the customer order information excluding the virtual personal information when the primary product supplier system (400) provides the customer order information excluding the virtual personal information, and request waybill output simultaneously with providing the generated delivery information to the secure waybill management means (200).

### Advantageous Effects

The present invention provides an effect of being able to make online shopping significantly convenient by allowing online shopping customers to order and receive products using simple virtual personal information without having to input actual personal information as customer information each time the customers make a purchase at an online shopping mall or place an order.

In addition, the present invention provides an effect of being able to eliminate a risk of massive leakage of actual personal information of customers, which has conventionally occurred when actual identity information of the customers was stored in each online shopping mall, by storing actual personal information provided by customers as delivery information only once in an independent secure waybill issuance system and storing only virtual personal information instead of actual personal information in online shopping, etc.

In addition, the present invention provides an effect of being able to fundamentally eliminate a risk of a massive leakage of customer information by preventing product suppliers, etc. from storing not only actual personal information but also virtual personal information.

In addition, the present invention provides an effect of being able to eliminate a risk of fraudulent issuance of waybills by checking customer order numbers, product supplier accounts, etc. when generating waybill information.

In addition, the present invention provides an effect in which a primary product supplier of an online shopping mall registers the primary product supplier and subordinate product suppliers thereof (secondary to Nth product suppliers) using an online shopping mall access account thereof in a secure waybill management means, so that all of the subordinate product suppliers (secondary to Nth product suppliers) may output a waybill using a secure waybill issuance system with the access account registered by the primary product supplier without going through the primary product supplier.

### DESCRIPTION OF DRAWINGS

FIG. 1 illustrates a conventional order delivery system.

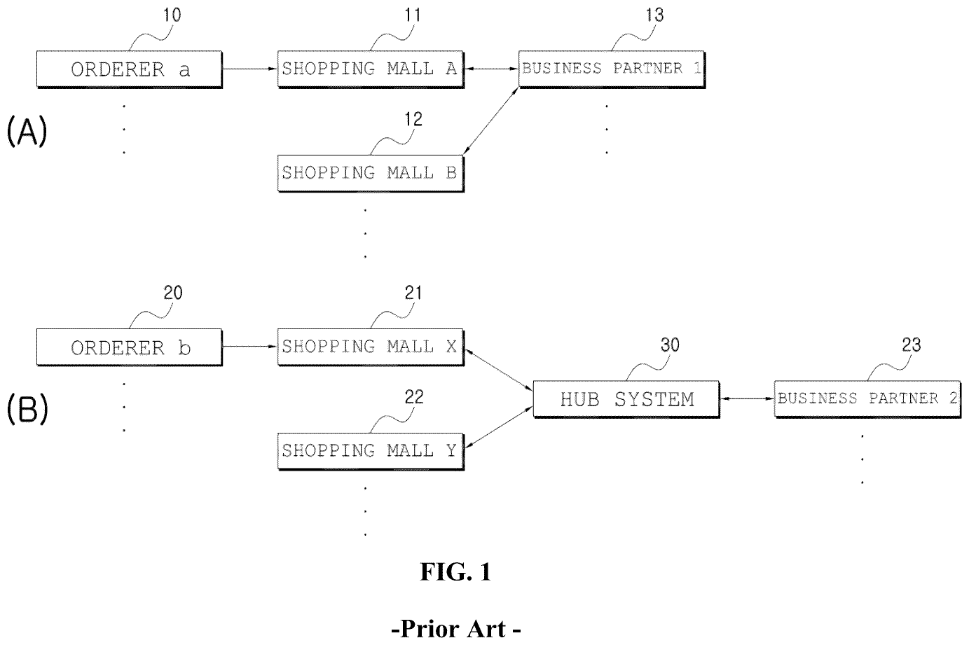

FIG. 2 is a configuration diagram of a secure waybill issuance management system of the present invention.

FIG. 3 is a detailed configuration diagram of a secure waybill management means of the present invention.

### DESCRIPTION OF REFERENCE SYMBOLS

100: customer terminal
200: secure waybill management means
300: shopping mall system
400: primary product supplier system
500: secondary to Nth product supplier systems
600: courier system

### MODE FOR INVENTION

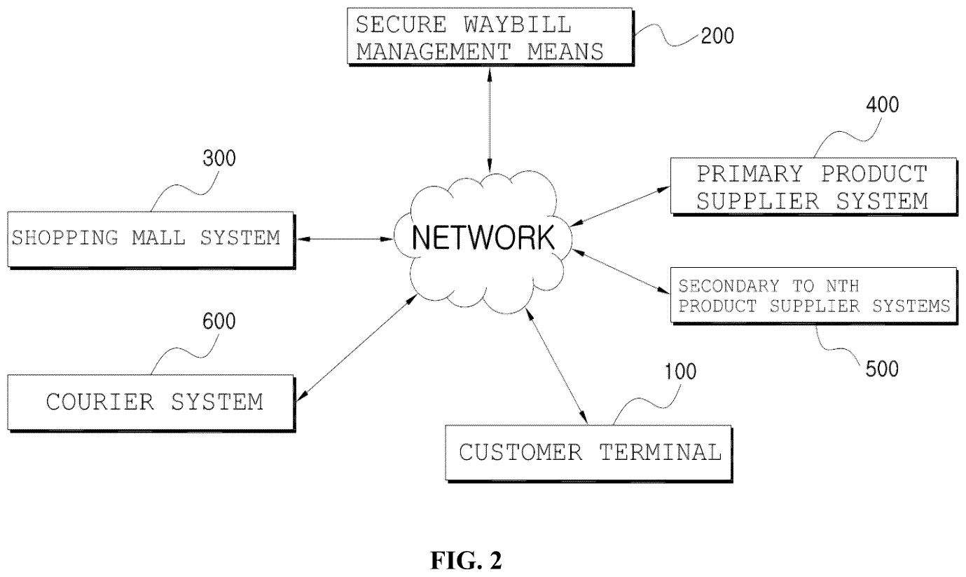

A system and method for managing issuance of a secure waybill using blockchain technology and virtual personal information are the invention capable of more safely and conveniently outputting a waybill without personal information leakage by using virtual personal information instead of actual personal information when a customer purchases a product from each online shopping mall, checking an online shopping mall customer order number to prevent fraudulent issuance of the waybill when outputting the waybill, and not storing identity information of the customer in a primary product supplier system and a subordinate product supplier system of the online shopping mall, and is characterized by including a customer terminal 100, a secure waybill management means 200, a shopping mall system 300, a primary product supplier system 400, and secondary to Nth product supplier systems 500 as illustrated in FIG. 2.

Specifically, as illustrated in FIG. 2, the system for managing issuance of a secure waybill using blockchain technology and virtual personal information is characterized by including

the customer terminal 100 configured to provide actual personal information of a customer to the secure waybill management means 200, receive virtual personal information of the customer corresponding to the actual personal information of the customer, and provide order information and the virtual personal information to the shopping mall system 300 for product purchase,

the secure waybill management means 200 configured to generate the virtual personal information of the customer corresponding to the actual personal information of the customer provided by the customer terminal 100, provide the generated virtual personal information to the customer terminal 100, store and manage the virtual personal information and the actual personal information of the customer using blockchain technology, form, store, and manage shopping mall access account relationship information of a primary product supplier and secondary to Nth product suppliers according to an access account registration request from the primary product supplier system 400, determine whether to generate waybill information using information provided by the shopping mall system 300 and the product supplier systems 400 and 500, and transmit the generated waybill information to an output unit of a product supplier system requesting waybill output,

the shopping mall system 300 configured to generate customer order information including the virtual personal information and a customer order number using the order information and the virtual personal information provided by the customer terminal 100, provide customer order information excluding the virtual personal information in the generated customer order information to the primary product supplier system 400, and provide the customer order information, shopping mall access account information of the primary product supplier system, and order status information to the secure waybill management means 200,

the primary product supplier system 400 configured to request that the secure waybill management means 200 register a shopping mall access account thereof and register the secondary to Nth product suppliers, which are subordinate product suppliers thereof, in the shopping mall access account thereof, generate delivery information using customer order information excluding the virtual personal information provided by the shopping mall system 300 when the primary product supplier system 400 supplies a purchased product of the customer, request waybill output simultaneously with providing the generated delivery information to the secure waybill management means 200, and provide the customer order information excluding the virtual personal information provided by the shopping mall system 300 to a subordinate product supplier system to provide a product without generating delivery information when the purchased product of the customer is supplied through a subordinate product supplier system thereof, and the secondary to Nth product supplier systems 500 configured to generate delivery information using the customer order information excluding the virtual personal information when the primary product supplier system 400 provides the customer order information excluding the virtual personal information, and request waybill output simultaneously with providing the generated delivery information to the secure waybill management means 200.

The customer terminal 100 of the present invention is configured to provide the actual personal information of the customer to the secure waybill management means 200 to receive the virtual personal information of the customer corresponding to the actual personal information of the customer, and provide the order information and the virtual personal information to the shopping mall system 300 for product purchase.

The customer terminal 100 is connected to the secure waybill management means 200 via a wired/wireless communication network, and displays an information input page provided by the secure waybill management means 200 on a screen, allowing the customer to input actual personal information of the customer.

In this instance, the actual personal information input on the information input page includes basic personal information such as name, contact information (mobile phone number), and address information.

In addition, the customer may additionally input desired virtual personal information when inputting actual personal information of the customer on the information input page.

The customer provides actual personal information of the customer or actual personal information and desired virtual personal information of the customer to the secure waybill management means 200 through the customer terminal 100, and receives registered virtual personal information of the customer corresponding to the actual personal information of the customer from the secure waybill management means 200.

In this instance, the virtual personal information provided from the secure waybill management means 200 may be in the form of numbers, letters, or a combination of numbers and letters.

In addition, the virtual personal information of the customer may be virtual information presented by the customer to the secure waybill management means 200 in the hope of using the information, or may be virtual information arbitrarily given by the secure waybill management means 200 when the customer does not provide virtual personal information.

In addition, the customer terminal 100 provides order information and virtual personal information to the shopping mall system 300 for product purchase, wherein the order information is information about the product to be purchased, and the virtual personal information is information to be used as delivery address information.

In the past, the actual personal information of the customer has been used as the delivery address information, but in the present invention, virtual personal information given from the secure waybill management means is used as the delivery address information.

Meanwhile, to be given the virtual personal information, the customer may provide the actual personal information of the customer to the secure waybill management means 200 using the customer terminal 100 as described above. However, a separate offline terminal 280 operated by the secure waybill management means 200 may be used.

The secure waybill management means 200 of the present invention is configured to generate the virtual personal information of the customer corresponding to the actual personal information of the customer provided by the customer terminal 100, provide the generated virtual personal information to the customer terminal 100, store and manage the virtual personal information and the actual personal information of the customer using blockchain technology, form, store, and manage shopping mall access account relationship information of a primary product supplier and secondary to Nth product suppliers according to an access account registration request from the primary product supplier system 400, determine whether to generate a waybill using information provided by the shopping mall system 300 and the product supplier systems 400 and 500, and transmit generated waybill information to an output unit of a product supplier system requesting waybill output.

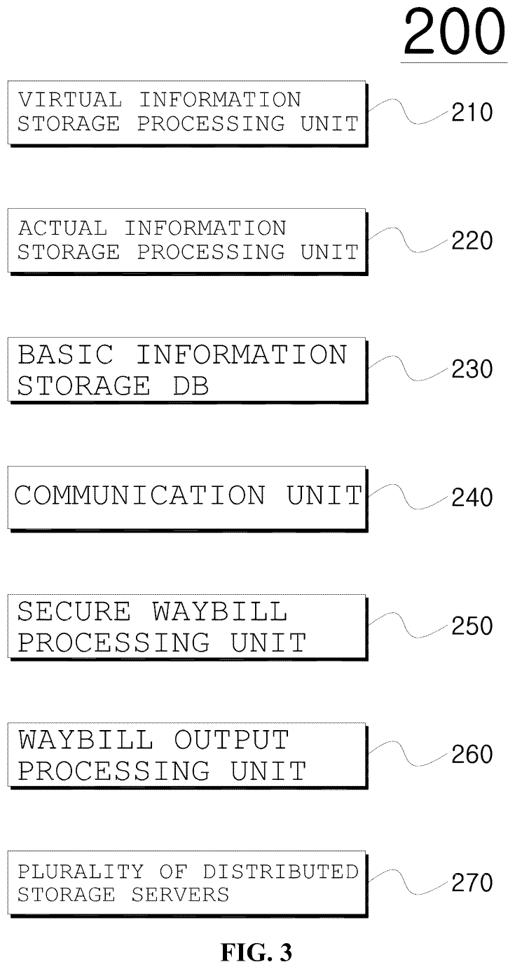

Specifically, as illustrated in FIG. 3, the secure waybill management means 200 is characterized by including

a virtual information storage processing unit 210 configured to provide the registered virtual personal information of the customer (virtual personal information desired by the customer or virtual personal information arbitrarily given) to the customer terminal 100 through a communication unit 240, match any hash value to the registered virtual personal information of the customer, and store and process the registered virtual personal information of the customer in a basic information storage DB 230,

an actual information storage processing unit 220 configured to match the same hash value used by the virtual information storage processing unit 210 to the actual personal information of the customer corresponding to the registered virtual personal information of the customer, generate customer information fragments in which the actual personal information of the customer and the hash value are matched, and distribute, store, and process the customer information fragments in a plurality of distributed storage servers 270,

the basic information storage DB 230 configured to store information including virtual personal information and hash value information matched to each other, shopping mall access account relationship information of product supplier systems, delivery information, customer order information, order status information, and courier delivery information, the communication unit 240 configured to allow the secure waybill management means 200 to have communication linkage with the customer terminal 100, the shopping mall system 300, the primary product supplier system 400, and the secondary to Nth product supplier systems 500 via the wired/wireless communication network, and transmit and receive various types of information,

a secure waybill processing unit 250 configured to form, store, and manage shopping mall access account relationship information of the primary product supplier and the secondary to Nth product suppliers according to an access account registration request from the primary product supplier system 400, determine whether to generate waybill information using information provided by the shopping mall system 300 and the product supplier systems 400 and 500, identify the actual personal information of the customer corresponding to the virtual personal information included in the customer order information when the generation of waybill information is determined to be needed, and generate waybill information by combining the identified actual personal information of the customer, the delivery information, and the courier delivery information,

a waybill output processing unit 260 configured to transmit the waybill information generated by the secure waybill processing unit 250 to the output unit of the product supplier system requesting waybill output so that the waybill information is output, and

a plurality of distributed storage servers 270 separately configured in a plurality of regions so that customer information fragments in which the actual personal information of the customer and the hash value are matched are distributed and stored.

The virtual information storage processing unit 210 is configured to provide the registered virtual personal information of the customer (virtual personal information desired by the customer or virtual personal information arbitrarily given) to the customer terminal 100 through the communication unit 240, match any hash value to the registered virtual personal information of the customer, and store the registered virtual personal information of the customer in the basic information storage DB 230.

When providing the virtual personal information desired by the customer, the virtual information storage processing unit 210 determines whether the virtual personal information presented by the customer is available information. When the virtual personal information is available information, the virtual information storage processing unit 210 registers the virtual personal information presented by the customer as valid virtual personal information, and provides the virtual personal information presented by the customer to the customer terminal 100 through the communication unit 240 as the registered virtual personal information of the customer. When the virtual personal information desired by the customer is not provided, the virtual information storage processing unit 210 gives arbitrary virtual personal information to the customer to register the information as valid virtual personal information, and provides the arbitrarily given virtual personal information to the customer terminal 100 through the communication unit 240 as the registered virtual personal information of the customer.

The registered virtual personal information of the customer provided through customer terminal 100 may be virtual information presented by the customer in the hope of using the information, or virtual information arbitrarily given by the virtual information storage processing unit 210, which may be information in the form of numbers, letters, or a combination of numbers and letters.

The virtual information storage processing unit 210 matches any hash value to the registered virtual personal information of the customer and stores the registered virtual personal information in the basic information storage DB 230. For example, the virtual information storage processing unit 210 stores the matched information in the form of (the virtual personal information of the customer (1234ab5678)—hash value (#123)) in the basic information storage DB 230.

The actual information storage processing unit 220 is configured to match the same hash value used by the virtual information storage processing unit 210 to the actual personal information of the customer corresponding to the registered virtual personal information of the customer registered in the actual information storage processing unit 220, generate customer information fragments in which the actual personal information of the customer and the hash value are matched, and distribute, store, and process the customer information fragments in the plurality of distributed storage servers 270.

Specifically, the actual information storage processing unit 220 is characterized by segmenting and dividing each of name information, contact information, and address information included in the actual personal information of the customer corresponding to the registered virtual personal information of the customer into a plurality of detailed information units, matching the same hash value used by the virtual information storage processing unit 210 to the plurality of segmented and divided detailed information units to generate customer information fragments in which the hash value is matched to the detailed information units, and distributing, storing, and processing the generated customer information fragments in the plurality of distributed storage servers 270.

For example, when an actual name of the customer included in the actual personal information of the customer is Hong Gil Dong, actual name information of the customer is segmented and divided into detailed information units, namely, “Hong”, “Gil”, and “Dong”. When actual contact information of the customer is 010-64 **_45 **, the actual contact information of the customer is segmented and divided into detailed information units, namely, “010”, “64 ** “, and “45 ** “. When actual address information of the customer is 11*, ** Dearo, Seo-gu, Daejeon, the actual address information of the customer is segmented and divided into detailed information units, namely, “11*”, “**-Dearo”, “Seo-gu”, and “Daejeon”.

When storing the virtual personal information of the customer, Hong Gil Dong, the virtual information storage processing unit 210 generates customer information fragments such as “#123-Hong”, “#123-Gil”, “#123-Dong”, “#123-010”, “#123-64 ** “, “#123-45 **” “#123-Daejeon”, “#123-Seo-gu”, “#123-**-Dearo”, and “#123-11*” obtained by matching the same hash value #123 to the plurality of segmented and divided detailed information units, namely, “Hong”, “Gil”, “Dong”, “010”, “64 ** “, “45 ** “, “11*”, “**-Dearo”, “Seo-gu”, and “Daejeon”.

The generated customer information fragments are distributed and stored in the plurality of distributed storage servers 270, and are distributed and stored so that two or more customer information fragments of the same customer are not stored in one distributed storage server 270.

In other words, to distribute and store the customer information fragments so that two or more customer information fragments of the same customer are not stored in one distributed storage server 270, the number of the plurality of distributed storage servers 270 needs to be greater than the number of generated customer information fragments. For example, when the number of customer information fragments generated by segmenting one piece of actual personal information is 10, the number of the plurality of distributed storage servers 270 needs to be 10 or more.

The basic information storage DB 230 is configured to store information including virtual personal information and hash value information matched to each other, shopping mall access account relationship information of product supplier systems, delivery information, customer order information, and order status information.

When a courier system 600 is included in the present invention, courier delivery information including collection information provided by the courier system 600 is additionally stored in the basic information storage DB 230.

The communication unit 240 is configured to allow the secure waybill management means 200 to communicate with the customer terminal 100, the shopping mall system 300, the primary product supplier system 400, and the secondary to Nth product supplier systems 500 via the wired/wireless communication network, and transmit and receive various types of information.

The secure waybill processing unit 250 is configured to form, store, and manage shopping mall access account relationship information of the primary product supplier and the secondary to Nth product suppliers according to an access account registration request from the primary product supplier system 400, determine whether to generate waybill information using information provided by the shopping mall system 300 and the product supplier systems 400 and 500, identify the actual personal information of the customer corresponding to the virtual personal information included in the customer order information when the generation of waybill information is determined to be needed, and generate waybill information by combining the identified actual personal information of the customer, the delivery information, and the courier delivery information.

The primary product supplier system 400, which will be described later, provides shopping mall access account information thereof and information about the secondary to Nth product suppliers, which are subordinate product suppliers thereof, to the secure waybill management means 200, and requests that the shopping mall access account of the primary product supplier system 400 be registered in a system of the secure waybill management means 200.

In response to the request, the secure waybill processing unit 250 forms, stores, and processes shopping mall access account relationship information of the primary product supplier and the secondary to Nth product suppliers, which are subordinate product suppliers thereof.

For example, when the shopping mall access account of the primary product supplier system 400 provided when the primary product supplier system 400 requests registration of the shopping mall access account is A, the secure waybill processing unit 250 forms, stores, and processes relationship information “access account A: the primary product supplier, and subordinate product suppliers of the primary product supplier, namely, the secondary to Nth product supplier”.

The stored relationship information between the access account and the product suppliers is used as confirmation information to determine whether to generate waybill information, which will be described later.

The shopping mall system 300 provides the shopping mall access account information and the order status information of the primary product supplier system and the customer order information to the secure waybill management means 200.

The customer order information provided by the shopping mall system 300 includes at least virtual personal information and a customer order number.

The access account information of the primary product supplier system, the customer order information including the virtual personal information and the customer order number, the order status information, etc., which are provided, are stored and processed in the basic information storage DB 230 of the secure waybill management means 200.

The access account information is access account information registered in the shopping mall system by the primary product supplier system to access the shopping mall system, and the customer order information is information generated by the shopping mall system according to an order of the customer, and includes the customer order number and the virtual personal information. The customer order number above is information contained in the customer order information generated according to the order of the customer, and refers to a number given to each order by the shopping mall system to perform product order management. The order status information indicates whether the order is a regular order, a return order, an exchange order, or order cancellation.

The product supplier system (either the primary product supplier system or one of the secondary to Nth product supplier systems) requests waybill output from the secure waybill management means 200 by providing delivery information including the customer order number. The delivery information including the customer order number is stored and processed in the basic information storage DB 230 of the secure waybill management means 200.

The secure waybill processing unit 250 determines whether to generate waybill information using information provided by the shopping mall system 300 and the product supplier systems 400 and 500 (the shopping mall access account information, the customer order number, the order status information, etc. of the primary product supplier system).

Specifically, the secure waybill processing unit 250 determines that waybill information needs to be generated upon confirmation that the shopping mall access account information of the primary product supplier system provided by the shopping mall system 300 is already present in the basic information storage DB 230, the customer order number included in the delivery information provided from the product supplier system is already present in the basic information storage DB 230, and the order status information stored in the basic information storage DB 230 is not order cancellation.

The waybill information is not generated when online shopping mall access account information of the primary product supplier system is not confirmed, the customer order number is not confirmed, or the order status information is order cancellation.

First, a description will be given of a verification process for access account information of the primary product supplier system of the secure waybill processing unit 250.

It is verified whether an access account of the primary product supplier system provided from the shopping mall system (referring to an account for accessing the shopping mall system) is an access account stored in the basic information storage DB 230.

As described above, the secure waybill processing unit 250 registers shopping mall access accounts of product suppliers according to the access account registration request from the primary product supplier system 400 in advance, and forms, stores, and processes access account relationship information between product suppliers.

Thereafter, it is verified whether the access account information provided from the shopping mall system is the access account information stored and processed in the basic information storage DB 230, which is intended to determine whether the product supplier requesting the waybill output is a normal product supplier system.

That is, the normal product supplier system needs to provide the same access account as the access account registered in the shopping mall system to the secure waybill management means.

When the same access account is not confirmed, the product supplier system is determined to be abnormal, and waybill information is not generated.

Next, a description will be given of a confirmation process for the customer order number of the secure waybill processing unit 250.

A customer order number is extracted from delivery information acquired from the product supplier system (the primary product supplier system or any one of the secondary to Nth product supplier systems), and the extracted customer order number is compared with the customer order numbers stored in the basic information storage DB 230 to verify whether the same customer order number is present.

The customer order information including the customer order number provided by shopping mall system 300 is stored and processed in the basic information storage DB 230.

That is, it is verified whether the customer order number included in the customer order information provided from the shopping mall system is the same as the customer order number extracted from the delivery information acquired from the product supplier system (the primary product supplier system or any one of the secondary to Nth product supplier systems).

When the same customer order number is not confirmed, it is determined that the product order is abnormal and waybill information is not generated.

That is, even when the same access account information described above is confirmed and the waybill output request is from a normal product supplier, if the same customer order number is not confirmed, the waybill output request is for an abnormal product order, and thus waybill information is not generated.

Next, a description will be given of a confirmation process for the order status information of the secure waybill processing unit 250.

The order status information provided by the shopping mall system 300 is stored and processed in the basic information storage DB 230.

The secure waybill processing unit 250 determines that waybill information needs to be generated when the order status information is a normal, return, or exchange order, and determines that waybill information is not generated when the order status information is order cancellation.

Meanwhile, when the courier system 600 is included in the present invention, the courier system 600 provides courier delivery information including collection information to the secure waybill management means 200, and the courier delivery information including the collection information is also stored and processed in the basic information storage DB 230 of the secure waybill management means 200.

In this case, the secure waybill processing unit 250 additionally uses the collection information included in the courier delivery information to determine whether to generate waybill information.

Specifically, the secure waybill processing unit 250 determines that waybill information needs to be generated upon confirmation that the shopping mall access account information of the primary product supplier system provided by the shopping mall system 300 is already present in the basic information storage DB 230, the customer order number included in the delivery information provided from the product supplier system is already present in the basic information storage DB 230, the order status information stored in the basic information storage DB 230 is not order cancellation, and collection information is not present in the basic information storage DB 230.

Hereinafter, a description will be given of a verification process for collection information of the secure waybill processing unit 250.

The courier system 600 provides courier delivery information including collection information to the secure waybill management means 200. In this case, the courier delivery information including the collection information provided by the courier system 600 is stored and processed in the basic information storage DB 230.

The secure waybill processing unit 250 verifies whether collection information is stored in the basic information storage DB 230. When the collection information is present, it means delivery has already occurred, so there is no need to generate waybill information. When collection information is not present, it means delivery has not occurred, so generation of waybill information is determined to be needed.

In other words, the secure waybill processing unit 250 determines that waybill information needs to be generated upon confirmation that shopping mall access account information and a customer order number of the same primary product supplier system are present, the order status information is not order cancellation, and collection information is not present.

When generation of waybill information is determined to be needed, the secure waybill processing unit 250 identifies the actual personal information of the customer corresponding to the virtual personal information included in the customer order information. Specifically, the secure waybill processing unit 250 is characterized by identifying a hash value matching virtual personal information to be used for generation of waybill information using information stored in the basic information storage DB 230, extracting customer information fragments matching the identified hash value from the plurality of distributed storage servers 270, and combining the extracted customer information fragments to identify the actual personal information of the customer corresponding to the virtual personal information of the customer.

A specific description will be given of identification of the actual personal information of the customer by the secure waybill processing unit 250.

The customer order information provided from the shopping mall system 300 includes virtual personal information and a customer order number.

Further, the delivery information provided from the product supplier system includes a customer order number.

When the customer order number included in the customer order information provided from the shopping mall system 300 is the same as the customer order number included in the delivery information provided from the product supplier system, the secure waybill processing unit 250 determines that the customer order number is normal, and identifies the virtual personal information included in the customer order information provided from the shopping mall system 300 as virtual personal information related to a product order for which waybill output is requested.

Next, a description will be given of a process of identifying the actual personal information of the customer corresponding to the identified virtual personal information.

Information having the virtual personal information of the customer and the hash value information matched each other is stored in the basic information storage DB 230 by the above-described virtual information storage processing unit 210, and customer information fragments in which the same hash value is matched with the segmented and divided actual personal information of the customer are distributed and stored in the plurality of distributed storage servers 270 by the above-described actual information storage processing unit 220.

For example, when the identified virtual personal information is 1234ab5678, and a hash value matched with the virtual personal information 1234ab5678 identified using information stored in the basic information storage DB 230 is identified as #123, the secure waybill processing unit 250 extracts customer information fragments matched with the identified hash value #123 from the plurality of distributed storage servers 270. For example, the customer information fragments matched with the hash value #123 (for example, “#123-Hong”, “#123-Gil”, “#123-Dong”, “#123-010”, “#123-64 ** “, “#123-45 ** “, “#123-Daejeon”, “#123-Seo-gu”, “#123-**-Dearo”, and “#123-11*”) are extracted from the plurality of distributed storage servers 270.

In addition, the secure waybill processing unit 250 combines the customer information fragments extracted from the plurality of distributed storage servers 270 to identify the actual personal information of the customer corresponding to the virtual personal information of the customer.

For example, when the customer information fragments extracted from the plurality of distributed storage servers 270 are “#123-Hong”, “#123-Gil”, “#123-Dong”, “#123-010”, “#123-64 ** “, “#123-45 ** “, “#123-Daejeon”, “#123-Seo-gu”, “#123-**-Dearo”, and “#123-11*”, the extracted customer information fragments “#123-Hong”, “#123-Gil”, “#123-Dong”, “#123-010”, “#123-64 ** “, “#123-45 ** “, “#123-Daejeon”, “#123-Seo-gu”, “#123-**-Dearo”, and “#123-11*” are combined to identify the actual personal information of the customer corresponding to the virtual personal information of the customer 1234ab5678 as “Hong Gil Dong-010-64 **-45 **-11, **-Dearo, Seo-gu, Daejeon”.

When the actual personal information of the customer is identified, the secure waybill processing unit 250 combines the identified actual personal information of the customer, the delivery information, and the courier delivery information to generate waybill information for a product order for which waybill output is requested.

The identified actual personal information of the customer, the delivery information, and the courier delivery information are combined to generate waybill information for a product order for which waybill output is requested.

The waybill output processing unit 260 is configured to transmit the waybill information generated by the secure waybill processing unit 250 to the output unit of the product supplier system requesting waybill output so that the waybill information is output.

That is, the generated waybill information is directly transmitted to the output unit of the product supplier system (the primary product supplier system or the secondary to Nth product supplier systems) requesting waybill output, thereby preventing the waybill information including the actual personal information of the customer from being stored and processed in the product supplier system.

The plurality of distributed storage servers 270 is separately configured in a plurality of regions so that the customer information fragments in which the actual personal information of the customer and the hash value are matched are distributed and stored.

For example, the customer information fragments “#123-Hong”, “#123-Gil”, “#123-Dong”, “#123-010”, “#123-64 ** “, “#123-45 ** “, “#123-Daejeon”, “#123-Seo-gu”, “#123-**-Dearo”, and “#123-11*” are distributed and stored in the plurality of distributed storage servers 270 by the above-mentioned actual information storage processing unit 220.

In particular, the customer information fragments are distributed and stored so that two or more customer information fragments of the same customer are not stored in one distributed storage server 270. To this end, the number of the plurality of distributed storage servers 270 needs to be greater than the number of generated customer information fragments. For example, when the number of customer information fragments generated by segmenting one piece of actual personal information is 10, the number of the plurality of distributed storage servers 270 needs to be 10 or more.

In addition, the plurality of regions where the plurality of distributed storage servers 270 is distributed may be different regions belonging to any one country or different countries distributed around the world.

The customer information fragments in which the actual personal information of the customer and the hash value are matched are distributed and stored in the plurality of distributed storage servers 270 separately configured in the plurality of regions to prevent leakage of the actual personal information of the customer through hacking, etc.

The shopping mall system 300 of the present invention is configured to generate customer order information including the virtual personal information and a customer order number using the order information and the virtual personal information provided by the customer terminal 100, provide customer order information excluding the virtual personal information in the generated customer order information to the primary product supplier system 400, and provide the customer order information, shopping mall access account information of the primary product supplier system, and order status information to the secure waybill management means 200.

The shopping mall system 300 uses order information, which is information about a product to be purchased, provided by the customer terminal 100 and virtual personal information, which is information to be used as delivery address information, to generate customer order information including the virtual personal information and the customer order number.

Thereafter, the shopping mall system 300 provides only customer order information excluding virtual personal information to the primary product supplier system 400, and provides customer order information including virtual personal information, shopping mall access account information of the primary product supplier registered in the shopping mall system, and order status information to the secure waybill management means 200.

The primary product supplier system 400 of the present invention is configured to request that the secure waybill management means 200 register a shopping mall access account thereof and register the secondary to Nth product suppliers, which are subordinate product suppliers thereof, in the shopping mall access account thereof, generate delivery information using customer order information excluding the virtual personal information provided by the shopping mall system 300 when the primary product supplier system 400 supplies a purchased product of the customer, request waybill output simultaneously with providing the generated delivery information to the secure waybill management means 200, and provide the customer order information excluding the virtual personal information provided by the shopping mall system 300 to a subordinate product supplier system to provide a product without generating delivery information when the purchased product of the customer is supplied through a subordinate product supplier system thereof.

The primary product supplier system 400 receives registration of an access account (a shopping mall access account of the primary product supplier) from the shopping mall system 300, and uses the access account to access the shopping mall system 300.

The primary product supplier system 400 provides a primary product supplier shopping mall access account information thereof to the secure waybill management means 200, requesting registration.

The secure waybill management means 200 receiving a request for registration of the access account forms relationship information between the access account and the product supplier, and stores the relationship information in the basic information storage DB 230.

For example, when the primary product supplier system 400 assumes that the shopping mall access account thereof registered from the shopping mall system 300 is A, relationship information “access account A-primary product supplier” is stored and processed in the basic information storage DB 230 of the secure waybill management means 200.

In addition, the primary product supplier system 400 requests that the secure waybill management means 200 register the secondary to Nth product suppliers, which are subordinate product suppliers thereof, with the access account thereof.

In this case, when registration is completed, the basic information storage DB 230 of the secure waybill management means 200 is updated with, stores, and processes the relationship information “access account A—the primary product supplier and the secondary to Nth product supplier”.

That is, product supplier information linked to online shopping mall access account information of the primary product supplier is stored and processed in the secure waybill management means in the form of a matching table, and is stored and processed in the format of “access account: product supplier”.

When the primary product supplier system 400 supplies a product purchased by the customer, the primary product supplier system 400 generates delivery information based on the customer order information excluding the virtual personal information provided by the shopping mall system 300, and requests waybill output while providing the generated delivery information to the secure waybill management means 200.

The customer order information provided to the primary product supplier system 400 from the shopping mall system 300 does not include virtual personal information.

That is, the shopping mall system 300 provides customer order information excluding virtual personal information to the primary product supplier system 400, so the delivery information provided by the primary product supplier system 400 to the secure waybill management means does not include virtual personal information but includes a customer order number.

In addition, the delivery information may include, in addition to the customer order number, courier information, an online shopping mall name, access account information, an expected collect date of the ordered product, a name of the ordered product, quantity of the ordered product, a price of the ordered product, the number of packaging boxes for packaging the ordered product, a type of packaging box, a delivery fee, a delivery message, etc.

In this instance, the access account information is the “online shopping mall access account information of the primary product supplier” for the primary product supplier system 400 to access the shopping mall system, and is access account information that the secure waybill management means 200 is requested to register by the primary product supplier system 400.

When the primary product supplier does not supply a product, and any one of the subordinate product suppliers thereof, namely, the secondary to Nth product supplier systems, supplies the product (when the primary product supplier system requests that any one of the subordinate product suppliers thereof, namely, the secondary to Nth product supplier systems, supply the product), customer order information excluding virtual personal information provided from the shopping mall system 300 is provided to any one of the secondary to Nth product supplier systems 500, which are subordinate product supplier systems thereof. In this instance, the primary product supplier system does not generate delivery information.

The secondary to Nth product supplier systems 500 according to the present invention are configured to generate delivery information using the customer order information excluding the virtual personal information when the primary product supplier system 400 provides the customer order information excluding the virtual personal information, and request waybill output simultaneously with providing the generated delivery information to the secure waybill management means 200.

Any one of the secondary to Nth product supplier systems 500 acquiring the customer order information (information not including the virtual personal information) generates delivery information based on the acquired customer order information (information not including the virtual personal information), and requests waybill output while providing the generated delivery information to the secure waybill management means.

The delivery information does not include the virtual personal information of the customer, and includes the customer order number.

In addition, the delivery information may include courier information, an online shopping mall name, access account information, an expected collect date of the ordered product, a name of the ordered product, quantity of the ordered product, a price of the ordered product, the number of packaging boxes for packaging the ordered product, a type of packaging box, a delivery fee, a delivery message, etc.

In this instance, the access account information is access account information of the primary product supplier system, which is the top product supplier of the secondary to Nth product suppliers. In other words, the access account information is the “online shopping mall access account information of the primary product supplier” for the primary product supplier system 400 to access the shopping mall system, and is access account information that the secure waybill management means 200 is requested to register by the primary product supplier system 400.

Meanwhile, the present invention is characterized by further including the courier system 600 configured to provide courier delivery information including collection information to the secure waybill management means 200 and process delivery of a product according to delivery request information provided by the secure waybill management means 200.

The courier system 600 is a concept including a courier for delivering an ordered product, and the courier delivery information provided to the secure waybill management means 200 by the courier system 600 may include collection information (collection point code, a collection point name, a collection date, etc.), destination terminal code, destination terminal name, a waybill number, etc.

The secure waybill management means 200 receiving the courier delivery information generates delivery request information and provides the generated delivery request information to the courier system 600.

The courier system 600 receiving the delivery request information processes delivery of the product according to the delivery request information.

In particular, the collection information included in the courier delivery information provided to the secure waybill management means 200 by the courier system 600 is used as basic information for determining whether to generate the above-described waybill information.

As described above, according to the present invention, the actual personal information of the customer is securely stored and processed only in the secure waybill management means 200, and is not stored and processed in the shopping mall system or the product supplier system, and thus it is possible to solve the problem of leakage of the actual personal information of the customer, which has occurred due to the actual personal information of the customer being stored and processed in the shopping mall system or the product supplier system for waybill output in the past.

In addition, the secure waybill management means 200 prevents fraudulent issuance of a waybill by determining whether to generate waybill information using the online shopping mall access account information, the customer order number, and the order status information of the primary product supplier system provided from the shopping mall system.

A method of managing issuance of a secure waybill using blockchain technology and virtual personal information, which is another embodiment of the present invention, is characterized by including
a step S10 of providing, by the customer terminal 100, the actual personal information of the customer to the secure waybill management means 200,
a step S20 of generating, by the secure waybill management means 200, the virtual personal information of the customer corresponding to the actual personal information of the customer and providing the virtual personal information to the customer terminal 100,
a step S30 of storing and managing, by the secure waybill management means 200, the virtual personal information and the actual personal information of the customer using blockchain technology,
a step S40 of providing, by the customer terminal 100, the order information and the virtual personal information to the shopping mall system 300 for product purchase,
a step S50 of forming, storing, and managing, by the secure waybill management means 200, the shopping mall access account relationship information of the primary product supplier and the secondary to Nth product suppliers according to the access account registration request from the primary product supplier system 400,
a step S60 of determining, by the secure waybill management means 200, whether to generate a waybill using information provided by the shopping mall system 300 and the product supplier systems 400 and 500, and generate waybill information using the actual personal information of the customer, the courier delivery information, and the delivery information when the generation of waybill information is determined to be needed,
a step S70 of transmitting the waybill information generated by the secure waybill management means 200 to the output unit of the product supplier system requesting waybill output so that the waybill information is output,
a step S80 of generating, by the shopping mall system 300, the customer order information including the virtual personal information and the customer order number using the order information and the virtual personal information provided by the customer terminal 100,
a step S90 of providing, by the shopping mall system 300, the customer order information excluding the virtual personal information in the generated customer order information to the primary product supplier system 400, and providing the customer order information, the shopping mall access account information of the primary product supplier system, and the order status information to the secure waybill management means 200,
a step S100 of requesting, by the primary product supplier system 400, that the secure waybill management means 200 register the shopping mall access account thereof and register the secondary to Nth product suppliers, which are subordinate product suppliers thereof, in the shopping mall access account thereof,
a step S110 of generating, by the primary product supplier system 400, delivery information using the customer order information excluding the virtual personal information provided by the shopping mall system 300, and requesting waybill output simultaneously with providing the generated delivery information to the secure waybill management means 200 when the primary product supplier system 400 supplies a purchased product of the customer, and providing the customer order information excluding the virtual personal information provided by the shopping mall system 300 to a subordinate product supplier system to provide a product without generating delivery information when a purchased product of the customer is supplied through a subordinate product supplier system thereof, and
a step S120 of generating, by the secondary to Nth product supplier systems 500, delivery information using the customer order information excluding the virtual personal information provided by the primary product supplier system 400, and requesting waybill output simultaneously with providing the generated delivery information to the secure waybill management means 200.

The step S30 is characterized by including
a step S31 of matching any hash value to the virtual personal information of the customer, and storing and processing the virtual personal information, and
a step S32 of matching the same hash value used in the step S31 to the actual personal information of the customer corresponding to the virtual personal information of the customer, generating customer information fragments in which the actual personal information of the customer and the hash value are matched to each other, and distributing, storing, and processing the customer information fragments.

The step S32 is characterized by segmenting and dividing each of name information, contact information, and address information included in the actual personal information of the customer corresponding to the virtual personal information of the customer into a plurality of detailed information units, matching the same hash value used in the step S31 to the plurality of segmented and divided detailed information units to generate customer information fragments in which the hash value is matched to the detailed information units, and distributing, storing, and processing the generated customer information fragments.

The step S60 is characterized by determining that waybill information needs to be generated upon confirmation that the shopping mall access account information of the primary product supplier system provided by the shopping mall system 300 and the customer order number included in the delivery information provided by the product supplier system are already stored in a storage means, and order status information stored in the storage means is not order cancellation.

In addition, the method of managing issuance of the secure waybill using the blockchain technology and the virtual personal information is characterized by further including
a step S130 of providing, by the courier system 600, the courier delivery information including the collection information to the secure waybill management means 200, and
a step S140 of generating, by the secure waybill management means 200, delivery request information and providing the delivery request information to the courier system 600.

When the step S130 and the step S140 are included in the method of managing issuance of the secure waybill using the blockchain technology and the virtual personal information, the step S60 is characterized by determining that waybill information needs to be generated upon confirmation that the shopping mall access account information of the primary product supplier system provided by the shopping mall system 300 and the customer order number included in the delivery information provided by the product supplier system are already stored in the storage means, order status information stored in the storage means is not order cancellation, and collection information is not present in the storage means.

Detailed characteristics of the method of managing issuance of the secure waybill using the blockchain technology and the virtual personal information having the above-described characteristics have been described in detail in a part of the system for managing issuance of the secure waybill using the blockchain technology and the virtual personal information, and thus a detailed description thereof will be omitted.

Even though the preferred embodiments of the present invention have been illustrated and described above, the present invention is not limited to the specific embodiments described above, and various modifications may be made by a person skilled in the art to which the invention pertains without departing from the gist of the present invention as claimed in the claims. Furthermore, such modifications should not be understood individually from the technical idea or prospect of the present invention.

### INDUSTRIAL APPLICABILITY

The present invention provides an effect of enabling online shopping to be significantly conveniently performed by allowing online shopping customers to order and receive products using simple virtual personal information without having to input actual personal information as customer information for each online shopping mall at which a purchase is made or each time an order is placed, and thus has high industrial applicability.

1. A system for managing issuance of a secure waybill using blockchain technology and virtual personal information, the system comprising:
a customer terminal (100) configured to provide actual personal information of a customer to a secure waybill management means (200), receive virtual personal information of the customer corresponding to the actual personal information of the customer, and provide order information and the virtual personal information to a shopping mall system (300) for product purchase;
the secure waybill management means (200) configured to generate the virtual personal information of the customer corresponding to the actual personal information of the customer provided by the customer terminal (100), provide the generated virtual personal information to the customer terminal (100), store and manage the virtual personal information and the actual personal information of the customer using blockchain technology, form, store, and manage shopping mall access account relationship information of a primary product supplier and secondary to Nth product suppliers according to an access account registration request from the primary product supplier system (400), determine whether to generate waybill information using information provided by the shopping mall system (300) and the product supplier systems (400 and 500), and transmit the generated waybill information to an output unit of a product supplier system requesting waybill output so that the waybill information is output;
the shopping mall system (300) configured to generate customer order information including the virtual personal information and a customer order number using the order information and the virtual personal information provided by the customer terminal (100), provide customer order information excluding the virtual personal information in the generated customer order information to the primary product supplier system (400), and provide the customer order information, shopping mall access account information of the primary product supplier system, and order status information to the secure waybill management means (200);
the primary product supplier system (400) configured to request that the secure waybill management means (200) register a shopping mall access account thereof and register the secondary to Nth product suppliers, which are subordinate product suppliers thereof, in the shopping mall access account thereof, generate delivery information using customer order information excluding the virtual personal information provided by the shopping mall system (300) when the primary product supplier system (400) supplies a purchased product of the customer, request waybill output simultaneously with providing the generated delivery information to the secure waybill management means (200), and provide the customer order information excluding the virtual personal information provided by the shopping mall system (300) to a subordinate product supplier system to provide a product without generating delivery information when the purchased product of the customer is supplied through a subordinate product supplier system thereof; and
the secondary to Nth product supplier systems (500) configured to generate delivery information using the customer order information excluding the virtual personal information when the primary product supplier system (400) provides the customer order information excluding the virtual personal information, and request waybill output simultaneously with providing the generated delivery information to the secure waybill management means (200).

2. The system according to claim 1, wherein the secure waybill management means (200) comprises:
a virtual information storage processing unit (210) configured to provide the registered virtual personal information of the customer (virtual personal information desired by the customer or virtual personal information arbitrarily given) to the customer terminal (100) through a communication unit (240), match any hash value to the registered virtual personal information of the customer, and store and process the registered virtual personal information of the customer in a basic information storage DB (230);
an actual information storage processing unit (220) configured to match the same hash value used by the virtual information storage processing unit (210) to the actual personal information of the customer corresponding to the registered virtual personal information of the customer, generate customer information fragments in which the actual personal information of the customer and the hash value are matched, and distribute, store, and process the customer information fragments in a plurality of distributed storage servers (270);
the basic information storage DB (230) configured to store information including virtual personal information and hash value information matched to each other, shopping mall access account relationship information of product supplier systems, delivery information, customer order information, and order status information;
the communication unit (240) configured to allow the secure waybill management means (200) to have communication linkage with the customer terminal (100), the shopping mall system (300), the primary product supplier system (400), and the secondary to Nth product supplier systems (500) via a wired/wireless communication network, and transmit and receive various types of information;
a secure waybill processing unit (250) configured to form, store, and manage shopping mall access account relationship information of the primary product supplier and the secondary to Nth product suppliers according to an access account registration request from the primary product supplier system (400), determine whether to generate waybill information using information provided by the shopping mall system (300) and the product supplier systems (400 and 500), identify the actual personal information of the customer corresponding to the virtual personal information included in the customer order information when the generation of waybill information is determined to be needed, and generate waybill information by combining the identified actual personal information of the customer, the delivery information, and courier delivery information;
a waybill output processing unit (260) configured to transmit the waybill information generated by the secure waybill processing unit (250) to the output unit of the product supplier system requesting waybill output so that the waybill information is output; and
a plurality of distributed storage servers (270) separately configured in a plurality of regions so that customer information fragments in which the actual personal information of the customer and the hash value are matched are distributed and stored.

3. The system according to claim 2, wherein the actual information storage processing unit (220) segments and divides each of name information, contact information, and address information included in the actual personal information of the customer corresponding to the registered virtual personal information of the customer into a plurality of detailed information units, matches the same hash value used by the virtual information storage processing unit (210) to the plurality of segmented and divided detailed information units to generate customer information fragments in which the hash value is matched to the detailed information units, and distributes, stores, and processes the generated customer information fragments in the plurality of distributed storage servers (270).

4. The system according to claim 2, wherein the secure waybill processing unit (250) determines that waybill information needs to be generated upon confirmation that the shopping mall access account information of the primary product supplier system provided by the shopping mall system (300) is already present in the basic information storage DB (230), the customer order number included in the delivery information provided from the product supplier system is already present in the basic information storage DB (230), and the order status information stored in the basic information storage DB (230) is not order cancellation.

5. The system according to claim 4, wherein:
the basic information storage DB (230) additionally stores courier delivery information including collection information provided by a courier system (600), and
the secure waybill processing unit (250) determines that waybill information needs to be generated upon confirmation that the shopping mall access account information of the primary product supplier system provided by the shopping mall system (300) is already present in the basic information storage DB (230), the customer order number included in the delivery information provided from the product supplier system is already present in the basic information storage DB (230), the order status information stored in the basic information storage DB (230) is not order cancellation, and collection information is not present in the basic information storage DB (230).

6. The system according to claim 2, wherein the secure waybill processing unit (250) identifies a hash value matching virtual personal information to be used for generation of waybill information using information stored in the basic information storage DB (230), extracts customer information fragments matching the identified hash value from the plurality of distributed storage servers (270), and combines the extracted customer information fragments to identify the actual personal information of the customer corresponding to the virtual personal information of the customer.

7. The system according to claim 1, further comprising a courier system (600) configured to provide courier delivery information including collection information to the secure waybill management means (200) and process delivery of a product according to delivery request information provided by the secure waybill management means (200), wherein the secure waybill management means (200) generates delivery request information and provides the delivery request information to the courier system (600).

8. A method of managing issuance of a secure waybill using blockchain technology and virtual personal information, the method comprising:
a step (S10) of providing, by a customer terminal (100), actual personal information of a customer to a secure waybill management means (200);
a step (S20) of generating, by the secure waybill management means (200), virtual personal information of the customer corresponding to the actual personal information of the customer and providing the virtual personal information to the customer terminal (100);
a step (S30) of storing and managing, by the secure waybill management means (200), the virtual personal information and the actual personal information of the customer using blockchain technology;
a step (S40) of providing, by the customer terminal (100), order information and the virtual personal information to a shopping mall system (300) for product purchase;
a step (S50) of forming, storing, and managing, by the secure waybill management means (200), shopping mall access account relationship information of a primary product supplier and secondary to Nth product suppliers according to an access account registration request from a primary product supplier system (400);
a step (S60) of determining, by the secure waybill management means (200), whether to generate a waybill using information provided by the shopping mall system (300) and product supplier systems (400 and 500), and generate waybill information using the actual personal information of the customer, courier delivery information, and delivery information when the generation of waybill information is determined to be needed;
a step (S70) of transmitting the waybill information generated by the secure waybill management means (200) to an output unit of a product supplier system requesting waybill output so that the waybill information is output;
a step (S80) of generating, by the shopping mall system (300), customer order information including the virtual personal information and a customer order number using the order information and the virtual personal information provided by the customer terminal (100);
a step (S90) of providing, by the shopping mall system (300), customer order information excluding the virtual personal information in the generated customer order information to the primary product supplier system (400), and providing the customer order information, shopping mall access account information of the primary product supplier system, and order status information to the secure waybill management means (200);
a step (S100) of requesting, by the primary product supplier system (400), that the secure waybill management means (200) register a shopping mall access account thereof and register the secondary to Nth product suppliers, which are subordinate product suppliers thereof, in the shopping mall access account thereof;
a step (S110) of generating, by the primary product supplier system (400), delivery information using customer order information excluding the virtual personal information provided by the shopping mall system (300), and requesting waybill output simultaneously with providing the generated delivery information to the secure waybill management means (200) when the primary product supplier system (400) supplies a purchased product of the customer, and providing the customer order information excluding the virtual personal information provided by the shopping mall system (300) to a subordinate product supplier system to provide a product without generating delivery information when a purchased product of the customer is supplied through a subordinate product supplier system thereof; and
a step (S120) of generating, by secondary to Nth product supplier systems (500), delivery information using customer order information excluding virtual personal information provided by the primary product supplier system (400), and requesting waybill output simultaneously with providing the generated delivery information to the secure waybill management means (200).

9. The method according to claim 8, wherein the step (S30) comprises:
a step (S31) of matching any hash value to the virtual personal information of the customer, and storing and processing the virtual personal information; and
a step (S32) of matching the same hash value used in the step (S31) to the actual personal information of the customer corresponding to the virtual personal information of the customer, generating customer information fragments in which the actual personal information of the customer and the hash value are matched to each other, and distributing, storing, and processing the customer information fragments.

10. The method according to claim 9, wherein the step (S32) comprises segmenting and dividing each of name information, contact information, and address information included in the actual personal information of the customer corresponding to the virtual personal information of the customer into a plurality of detailed information units, matching the same hash value used in the step (S31) to the plurality of segmented and divided detailed information units to generate customer information fragments in which the hash value is matched to the detailed information units, and distributing, storing, and processing the generated customer information fragments.

11. The method according to claim 8, wherein the step (S60) comprises determining that waybill information needs to be generated upon confirmation that the shopping mall access account information of the primary product supplier system provided by the shopping mall system (300) and a customer order number included in delivery information provided by the product supplier system are already stored in a storage means, and order status information stored in the storage means is not order cancellation.

12. The method according to claim 8, further comprising:
a step (S130) of providing, by a courier system (600), courier delivery information including collection information to the secure waybill management means (200); and
a step (S140) of generating, by the secure waybill management means (200), delivery request information and providing the delivery request information to the courier system (600).

13. The method according to claim 12, wherein the step (S60) comprises determining that waybill information needs to be generated upon confirmation that the shopping mall access account information of the primary product supplier system provided by the shopping mall system (300) and a customer order number included in delivery information provided by the product supplier system are already present in a storage means, order status information stored in the storage means is not order cancellation, and collection information is not present in the storage means.
